(19) United States
(12) Patent Application Publication
(10) Pub. No.: US 2009/0166310 A1
(43) Pub. Date: Jul. 2, 2009

(54) FLOW RESTRICTING FORMULA BOTTLE CAP

(76) Inventors: Mary Cote, Windham, NH (US); Theodore Cote, Manchester, NH (US); Carl Conforti, Fall River, MA (US)

Correspondence Address: Frank Marino;Sheehan Phinney Bass + Green, PA, 1000 Elm Street, PO Box 3701, Manchester, NH, 03105-3701, US

(21) Appl. No.: 11/837,231

(22) Filed: Aug. 10, 2007

Related U.S. Application Data
(60) Provisional application No. 60/837,769, filed on Aug. 15, 2006.

(51) Int. Cl. A61J 9/08

(52) U.S. Cl. 215/11.6

(57) ABSTRACT

A formula feeding device configured to adapt to a baby bottle assembly or like container, where the device has an internal shape configured to squeeze the nipple when in a closed position and allow the flow of formula through an nipple or like component when in the open position providing a method to efficiently mix formula in a bottle assembly or like container.

### RELATED APPLICATION

This application claims the benefit of U.S. Provisional Application No. 60/837,769, filed Aug. 15, 2006. The entire teachings of the referenced application are incorporated herein by reference.

### FIELD OF THE INVENTION

The invention relates to feeding infants and small animals and more specifically to bottle feeding newborns or like recipients of a powder formula mixed with a liquid from a nippled bottle or other like containers.

### BACKGROUND OF THE INVENTION

Newborns are often fed formula mixed with a liquid from nippled bottles. Such bottles and their nipples are preferably pre-sterilized for health and safety, so caps are often temporarily affixed to the bottle after sterilization and during storage and transportation to provide a desired leak-proof seal enclosure over the nipple. Such caps are generally sterilized with the bottles and nipples so that cross contamination is prevented from the cap to the nipple.

Baby formula is often sold in condensed liquid or in a dry powder forms, which must be mixed with a liquid, i.e. water or milk to form a milk-like consistency of proper concentration for feeding. The formula provides a convenience of storing the baby's food in a dry form, and can be conveniently mixed at anytime with a sterile liquid to provide liquid formula for feeding. The nipples of baby bottles are adapted to enable a baby to feed from free flowing milk or properly mixed formula where as a properly mixed concentrated solution of such formula will flow through the nipple orifice as the baby is fed.

There are several containers in the prior art in which powdered and condensed formulae may mixed before pouring it into the bottles, and which are adequate in creating a properly homogenized and concentrated solution, but many consumers prefer the simplicity of mixing the solution directly within the baby bottle by shaking, so the consumer can feed the young infant or newborn without additional handling of the formula and without the inconvenience and pre-sterilizing of such an added container.

Devices exist in the prior art, such as the “Nipple Klipper” of U.S. Pat. No. 5,318,191, for pinching the nipple of the bottle, such as during such shaking. But such devices have been found to be inadequate and inconvenient for reasons including;
a. They often shake loose from the nipple during vigorous shaking.
b. They do not enclose the nipple, and thereby allow solution to leak through the nipple during shaking and spray about, making a mess.
c. They do not enclose the nipple, and thereby allow solution to leak through the nipple during transport, making a mess.
d. They do not provide an enclosure around the nipple, and thereby allow post-sterilization contamination.
e. They do not fit to the bottle in cooperation with the nipple-covering cap.
f. They add cost and another inconvenient device that must be kept and sterilized.

As a result, most consumers have bypassed the use of such devices and resort to folding the nipple over with a finger or pinching the nipple between their fingers while shaking. But such a method, while convenient, suffers from several additional problems, including
a. Cross contamination from the consumer's fingers is likely.
b. The fingers can not often properly seal the nipple, and thereby allow solution to leak through the nipple during shaking and spray about, making a mess.
c. The fingers often become “dirty” and messy from solution that has leaked from the nipple during shaking.

Direct in-the-bottle mixing also has the tendency to result in a solution of formula and water that is incompletely and non-homogeneously mixed, mainly because the problems and inconveniences of such prior art devices and methods causes consumers to shake the bottles less vigorously and for less time than is needed for adequate mixing. This results in clumps of formula within the liquid.

Additionally, even solution that is properly mixed in advance may settle while stored and transported, with the formula falling in particles or clumps to the bottom, requiring shaking just prior to feeding. Such clumps and unmixed formula will clog the nipple during feeding and create difficulties for the baby even when the clumps are small enough to pass through the nipple.

There exists therefore a need of a device to assist mothers and other consumers in the homogeneous mixing of formula and liquid directly within nippled bottles or like containers, which is absent the aforementioned difficulties, inconveniences, and inadequacies.

There exists the additional need for such a device which does not add a component to the inventory of items that a consumer must purchase, sterilize, carry, and store.

There exists the additional need for such a device which provides a sealed enclosure around the nipple, prevents nipple contamination, retains inadvertently leaked solution and allows the pinching of the nipple without touching the nipple with the fingers and can be effectively used with a one hand operation.

### SUMMARY OF THE INVENTION

The present invention is a cap for use with a nippled bottle, in substitution for a traditional bottle nipple cap, which firmly pinches closed the nipple to prevent leakage during storage, transportation and vigorous shaking, and which provides a protective enclosure for the nipple. In certain examples, the invention is embodied in a “clam-shell” housing which is affixed to the bottle over the nipple by folding about a hinge to capture the nipple while pinching it closed. Such an arrangement and others disclosed and anticipated are found to provide a superior device and method for storing, transporting and shaking bottles of baby formula solution. No additional devices need be purchased, sterilized, carried, or stored, because the cap of the present invention substitutes for existing caps in covering and protecting the nipple when not feeding. The contamination and leaking prevalent in the prior art are eliminated. And the device may be embodied in an inexpensive, simple one piece, and reliable, integrally molded configuration. The bottle cover formula cap may further be configured to seal a variety of nipple styles within a configuration that may adapt to a portion of a bottle or like container assembly.

The cap may be configured to have an external shape to be grasped by a consumer preferably with one hand, pivotably hinged about a primary axis, and may further comprise an inner detail configured to pinch off a portion of a nipple at a desired height to prevent particles from blocking the feed hole on the nipple body when mixing formula with a liquid. The inner detail may be further configured to adapt to a variety of nipple configurations, in addition to being configured with a locking feature that prevents the formula cap from detaching from the bottle assembly. The external detail of the formula cap is configured to allow a user to assemble, hold, and shake the entire assembly and prevent leaking from the feeding bottle or like container.

Other features and advantages will be appreciated upon a review of the following description of various exemplary embodiments of the invention, along with the appended drawings. It should however be appreciated that although the accomplishment of each of the foregoing objects in a single embodiment of the invention may be possible and indeed preferred, not all embodiments will seek or need to accomplish each and every potential object and advantage. Nonetheless, all such embodiments taught and or encompassed by the appended claims should be considered within the scope of the present invention.

### BRIEF DESCRIPTION OF THE FIGURES

Many aspects of the invention can be better understood with reference to the appended drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a side view of a baby bottle flow-restricting cap according to a first exemplary embodiment,

FIG. 1B is atop view of the cap of FIG. 1A,

FIG. 1C is a cross-sectional view of the cap of FIG. 1A in its open configuration,

FIG. 2A is a side view of a cap according to a second exemplary embodiment,

FIG. 2B is a top view of the cap of FIG. 2A,

FIG. 3A is a side view of a cap according to a third exemplary embodiment,

FIG. 3B is a top view of the cap of FIG. 3A,

FIG. 3C is an exploded view of the cap of FIG. 3A in its open configuration,

FIG. 4A is a side view of a cap according to a fourth exemplary embodiment,

FIG. 4B is a top view of the cap of FIG. 4A, and

FIG. 5 is a perspective view of a cap according to a fifth exemplary embodiment.

### DETAILED DESCRIPTION OF PREFERRED EMBODIMENTS

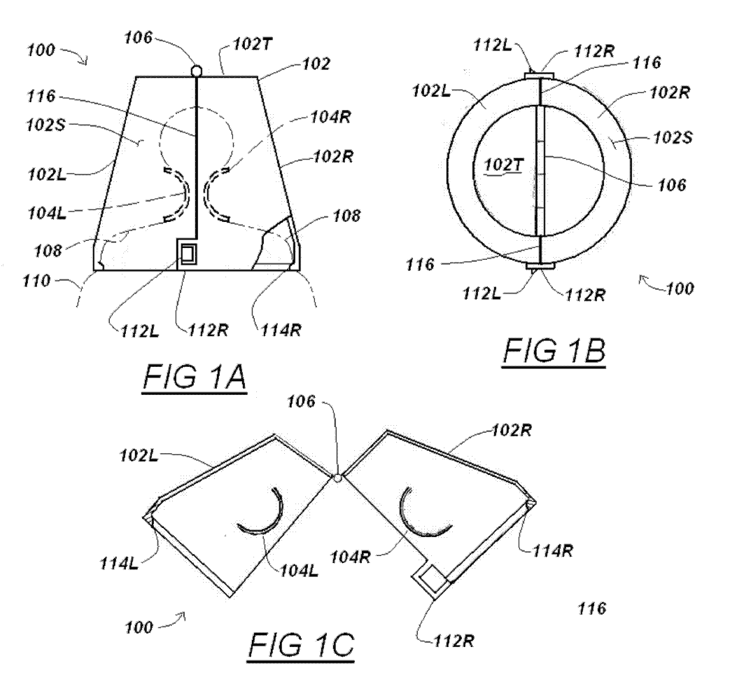

Referring first to FIGS. 1A to 1C, a first exemplary formula cap 100 includes an outer shell 102 which may fit over and encapsulate a typical nipple 108 of a typical baby bottle 110. The shell is comprised of a left shell portion 102L and a right shell portion 102R connected together and pivotable about hinge 106. The shell also comprises a top surface 102T and a skirt 102S depending downwardly from the top surface towards the bottle, the top surface and skirt shared by portions 102R and 102L, with each bisected along joint 116.

Integrally formed within each shell portion is a pinching member; left pinching member 104L within left shell portion 102L and right pinching member 104R within right shell portion 102R. The pinching members are disposed and shaped to cooperatively pinch the nipple 108 closed, as seen in FIG. 1A, when the shell portions are closed about the hinge onto the nipple.

Connector portions 112R and 112L cooperate to temporarily affix the shell portions together when the shell portions are closed, holding the cap shut against the outward force exerted on the pinching members by the compressed nipple. Clasp 112R is configured to ride outwardly over tapered boss 112L and grasp around the boss as the shell portions come together. To open the shell portions, claps 112R are pulled outwardly and the outward pressure exerted by the compressed nipple 108 on the pinching members 104R and 104L causes the cap to spring open.

When in the closed position of FIG. 1A, semi-annular inner rings 114R and 114L cooperate to grasp the underside of nipple 108, thereby holding the cap to the bottle for protecting the nipple such as during storage or transportation.

Shell portions 102R and 102L of cap 100 may be formed individually and connected at hinge 106, or else may be formed integrally as a single unitary structure, with the hinge being a flexible and resilient “living hinge”. The entire cap assembly is preferable molded of a plastic material which is capable of withstanding the high temperatures of dishwashing and boiling water, so that the cap may be sterilized with the nipples and bottles. Such materials as high-temperature polypropylene and polyethylene are preferred, especially in designs employing a living hinge.

As should be appreciated, when cap 100 is in its closed position and nipple 108 is pinched firmly closed, solution within bottle 110 is unable to escape through the nipple, thereby allowing the bottle to be transported and vigorously shaken without fear of inadvertent leakage. By allowing such vigorous spill-free shaking, proper mixing of the formula and liquid within the bottle is ensured, and the aforementioned problematic clumps may be eliminated.

It should also be appreciated that cap 100 provides an ideal container for nipple 108 during storage, transportation and shaking, so that the user's fingers need never touch the nipple and the nipple may remain sterilized and mess-free.

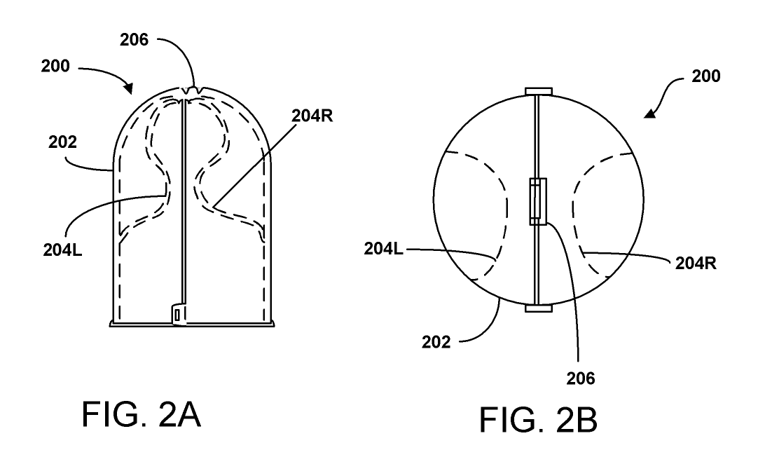

Additional exemplary embodiments of various other caps according to the invention are shown in FIGS. 2A through 5. FIGS. 2A and 2B show a cap 200 similar to the first embodiment except having a semi-spherically-shaped shell 202 and a living hinge 206. Pinching members 104L and 104R are shaped to conform closely to a nipple.

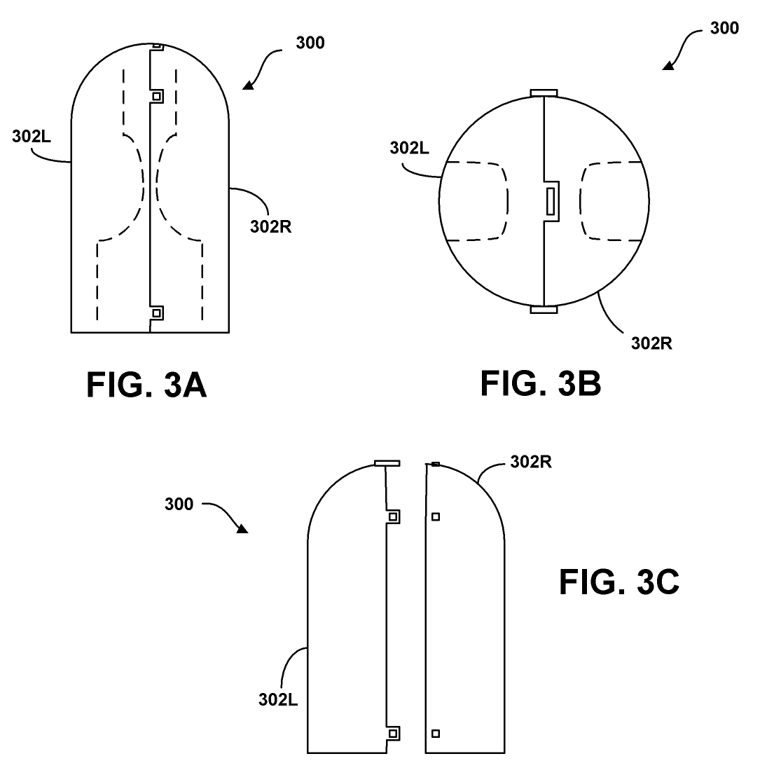

FIGS. 3A to 3C show a third exemplary embodiment of a cap 300, which is constructed in separable shell portions 302R and 302L.

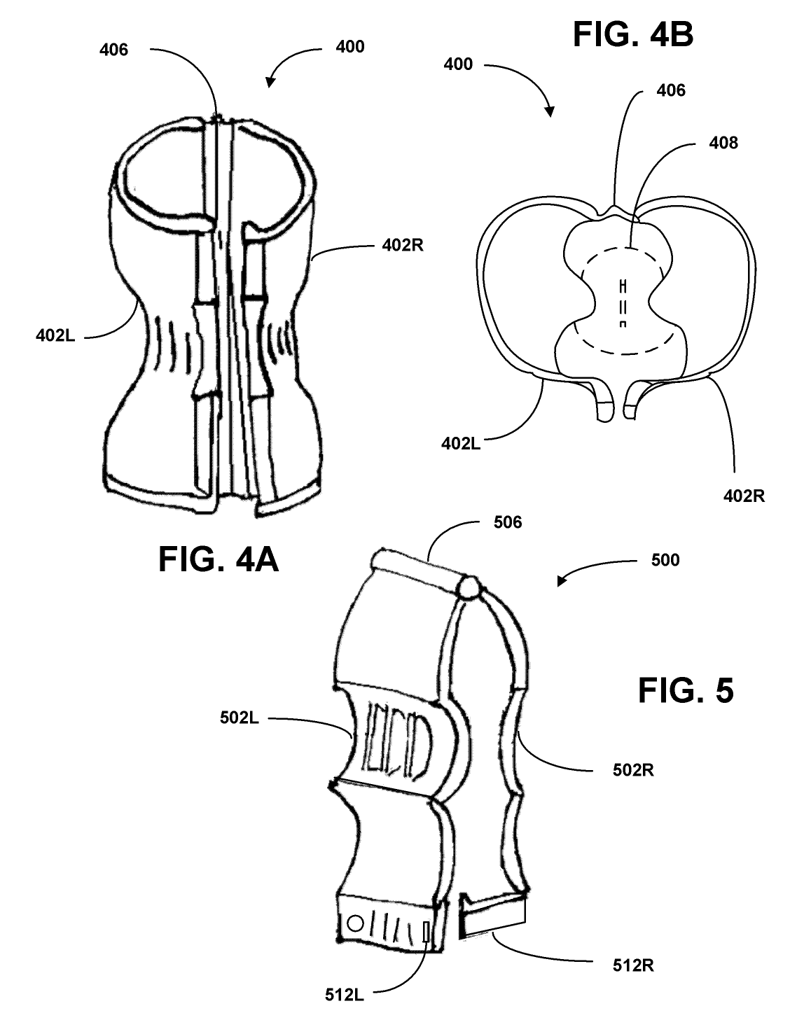

In FIGS. 4A and 4B, there is shown a fourth exemplary embodiment wherein open-topped cap 400 comprises semi-cylindrical shell portions 402R and 402L which are connected along vertical hinge 406 so that the portions close around nipple 408 from the side.

In FIG. 5 there is shown a fifth exemplary embodiment wherein open-side cap 500 comprises shell portions 502R and 502L which are connected along horizontal hinge 506 and which are connected by connector portions 512L and 512R.

From the foregoing, it will be clear that the present invention has been shown and described with reference to certain preferred embodiments that merely exemplify the broader invention revealed herein. Certainly, those skilled in the art can conceive of alternative embodiments. For instance, those with the major features of the invention in mind could craft embodiments that incorporate one or more major features while not incorporating all aspects of the foregoing exemplary embodiments.

With this in mind, the claims that follow will define the scope of protection to be afforded the invention, and those claims shall be deemed to include equivalent constructions insofar as they do not depart from the spirit and scope of the present invention. Certain of these claims express certain elements as a means for performing a specific function, at times without the recital of structure or material. As the law demands, any such claims shall be construed to cover not only the corresponding structure and material expressly described in the specification but also equivalents thereof.

We claim:

1. A cap for use with a nippled bottle and comprising:
a shell affixable to the bottle to form an enclosure surrounding the nipple, said shell comprising a first portion and a second portion, wherein said second portion is removably engageable with said first portion to form said enclosure.

2. The cap of claim 1 wherein said first portion comprises a first pinch member and said second portion comprises a second pinch member, and said first and second pinch members cooperate to pinch the nipple and prevent flow there-through when said first and second portions are engaged.

3. The cap of claim 2 wherein said first pinch member is integrally formed with said first portion and said second pinch member is integrally formed with said second portion.

4. The cap of claim 3 wherein said first and second portions are connected by a hinge and said first and second portions are engageable by relative rotation about said hinge.

5. The cap of claim 4 wherein said first portion, second portion and hinge are integrally formed of a resilient material.

6. The cap of claim 5 wherein said resilient material is a polymer and said first portion, second portion and hinge are integrally formed by molding.

7. The cap of claim 2 wherein said first and second portions are connected by a hinge and said first and second portions are engageable by relative rotation about said hinge.

8. The cap of claim 7 wherein said first portion, second portion and hinge are integrally formed of a resilient material.

9. The cap of claim 8 wherein said resilient material is a polymer and said first portion, second portion and hinge are integrally formed by molding.

10. The cap of claim 9 wherein said first pinch member is integrally molded of said first portion and said second pinch member is integrally molded of said second portion.

11. A cap for use with a nippled bottle and comprising:
a unitary shell molded of a resilient polymer and affixable to the bottle to form an enclosure surrounding the nipple, said shell comprising a first cap portion and a second cap portion connected by a living hinge, wherein said second cap portion is removably engageable about said living hinge with said first cap portion to form said enclosure, and wherein said first cap portion comprises a first pinch member and said second cap portion comprises a second pinch member, and said first and second pinch members cooperate to pinch the nipple and prevent flow there-through when said first and second cap portions are engaged.

12. The cap of claim 11, further comprising a horizontal top surface and a skirt depending substantially vertically from and below said top surface, wherein said top surface and said skirt are each bisected by said first and second cap portions along a linear bisection joint.

13. The cap of claim 12, wherein said living hinge is horizontally disposed adjacent said top surface along said bisection joint.

14. The cap of claim 13, wherein said first cap portion comprises a first connector portion disposed adjacent said bisection joint and said second cap portion comprises a second connector portion disposed adjacent said bisection joint and said first and second connector portions cooperate to temporarily affix said first and second cap portions to each other and to said bottle when said first and second cap portions are engaged.

15. The cap of claim 12 wherein said living hinge is substantially vertically disposed adjacent said skirt along said bisection joint.

16. The cap of claim 13 wherein said first cap portion comprises a first connector portion disposed adjacent said bisection joint and said second cap portion comprises a second connector portion disposed adjacent said bisection joint and said first and second connector portions cooperate to temporarily affix said first and second cap portions to each other and to said bottle when said first and second cap portions are engaged.

17. The cap of claim 16 wherein said first and second connector portions are each disposed transverse said first and second cap portions, respectively, from said living hinge.

18. A method for capping a nippled bottle comprising:
affixing a shell to the bottle to form an enclosure surrounding the nipple, wherein said shell comprises a first portion and a second portion, and wherein said second portion is removably engageable with said first portion to form said enclosure.

19. The method of claim 18 wherein said first portion comprises a first pinch member and said second portion comprises a second pinch member, and said method further comprises causing said first and second pinch members to cooperate to pinch the nipple and prevent flow there-through when said first and second portions are engaged.

20. The method of claim 19 wherein said first and second portions are connected by a hinge and said method further comprises engaging said first and second portions by relative rotation about said hinge.
